(19) United States
(12) Patent Application Publication
(10) Pub. No.: US 2015/0232267 A1
(43) Pub. Date: Aug. 20, 2015

(54) Portable Trash Bag Holder

(71) Applicant: David Allen Leach, Hesperia, CA (US)

(72) Inventor: David Allen Leach, Hesperia, CA (US)

(21) Appl. No.: 14/534,532

(22) Filed: Nov. 6, 2014

Related U.S. Application Data
(60) Provisional application No. 61/904,516, filed on Nov. 15, 2013.

(51) Int. Cl. B65F 1/14; F16B 2/22

(52) U.S. Cl. CPC B65F 1/1415; F16B 2/22; B65F 2210/00

(57) ABSTRACT

A portable hand held hoop made of PVC pipe which affords the opening of a plastic trash bag to remain open while collecting litter or other refuse so as not having to constantly fight with the bag to deposit the collection. Said bag is placed onto the hoop with the opening draping over the hoop and held securely on the hoop with a few plastic snap on damps provided.

### CROSS-REFERENCE TO RELAYED APPLICATIONS

This application refers to a previous Provisional Application No. 61,904,516 Dated Nov. 15, 2013. With David A. Leach listed as the inventor. That this date shall have priority as the effective patent date for this Non-Provisional Utility Patent.

### STATEMENT REGARDING FEDERALLY SPONSORED RESEARCH OR DEVELOPMENT.

Not applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

Not Applicable

### BACKGROUND OF THE INVENTION

(1) Field of Invention

From my own personal experiences I relate to the difficulty of the time spent trying to perform litter pick up and the time spent trying to get the opening of a trash bag open every time I pick something up. Seems more time is wasted fighting with the bag than actual litter pick up.

This invention relates specifically to a hand held portable trash bag holder as it relates to the ability of keeping the bag open at all times making it easier to deposit items into the bag.

(2) Description of Related Art

Other bag holders which keep bags in the open position are usually heavy and cumbersome to deal with, such as your usual trash containers and are basically used in a stationary situation. Other hand held bag holder are made with materials which deteriorate over a period of time and are unable to carry any substantial amount of weight.

Dwy in U.S. Pat. No. 5,718,400 shows an example of a hand held devise which appears to be serviceable but difficult if not uncomfortable to carry.

Stanfield in U.S. Pat. No. 6,604,717 shows a hand held devise which utilizes metal spring clips for retaining a trash bag which could rust over a period of time needing replacement.

Peterson in U.S. Pat. No. 7,753,322 depicts a hand held devise that holds the trash bag in place with an elastic band which would deteriorate over a period and would have to be replaced.

### BRIEF SUMMARY OF THE INVENTION

This invention is a portable hand held plastic trash bag holder formed in the shape of a hoop which affords the opening of the trash bag to remain open while walking around collecting trash, litter, recyclable or other debris. The trash bag remains affixed to the devise utilizing plastic snap clamps which are provided thus allowing the operator to carry an open trash bag with one hand leaving their second hand to be free to work.

Therefore it is the object of this invention to provide an improved lightweight, easy to carry and simple devise which one could carry an open trash bag with one hand while leaving a second band free and available for collecting recyclables, litter or other debris.

It is further the object of this invention to be able to withstand the test of time, being made entirely of plastic having nothing to rust or wear out and utilizing plastic clamps which are capable of securing a bag while holding a substantial amount of weight.

It is further still the object of this invention to be able to produce cost effectively trash bag holders which can be easily made in different sizes to accommodate trash bags with different capacities.

### BRIEF DESCRIPTION OF THE SEVERAL VIEWS OF THE DRAWINGS

FIG. 1) Section of PVC Pipe, heated and formed into shape.

FIG. 2) PVC Couplers attached to each end of the formed pipe.

FIG. 3) PVC pipe stubbing to hold the couplers together.

FIG. 4) Hand Grip made of Poly Vinyl material which covers the two couplers.

FIG. 5) A series of ABS Snap Clamps for securing the trash bag to the hoop.

### DETAILED DESCRIPTION OF THE INVENTION

This is a hand held portable devise which keeps the opening of a plastic trash bag open while collecting litter, trash and other debris.

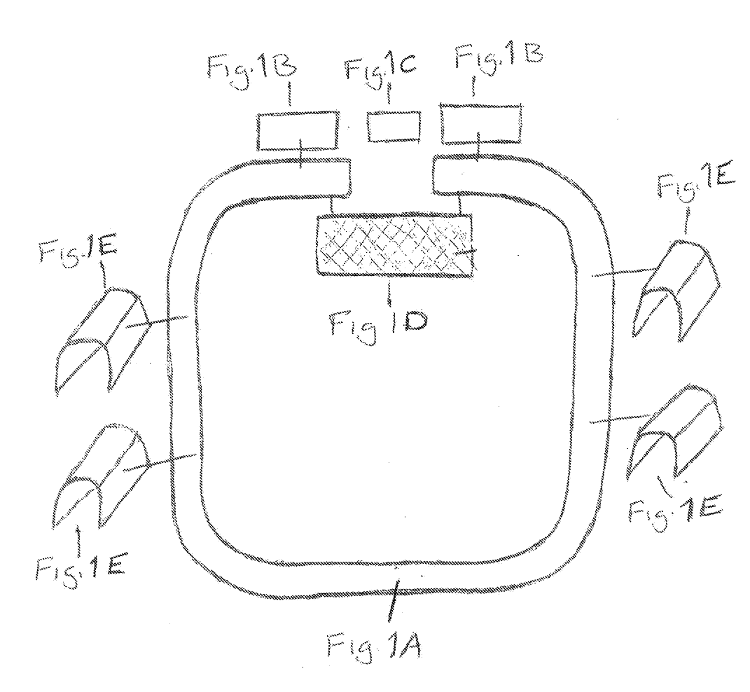

It is fabricated from PVC pipe, FIG. 1, which is heated to approximately 225 degrees F. and formed into a semi-square shape. The ends of the pipe are held together with (2) two PVC Pipe Couplers, FIG. 2, and a short section of PVC pipe, FIG. 3, between the couplers.

These two fittings constitute a handle, or hand grip, which is in turn fitted into a piece of Poly-Vinyl material, FIG. 4, which allows for easy comfortable handling.

A plastic trash bag is then inserted through the hoop while folding the open end of the bag over the four sides of the hoop. Once the bag is open and draping over the hoop the operator they fastens the bag to the hoop by using the ABS snap Clamps. FIG. 5, provided with each device.

### SEQUENCE LISTING

Not Applicable

What is claimed is:

1. A portable hand held trash bag holder designed to hold the opening of a plastic trash bag open consisting of:
a) a devise shaped into a semi-square shape, considered as the hoop, having a circumference slightly smaller than that of the opening of the bag being used,
b) a series of clips for the purpose of securing said trash bag to the bag holder,
c) a soft comfortable hand grip for easy handling and carrying.

2. A trash bag holder as claimed in claim one, where the hoop and clips are made of plastic.
